(19) United States
(12) Patent Application Publication
(10) Pub. No.: US 2026/0364826 A1
(43) Pub. Date: Nov. 19, 2026

(54) METHOD FOR CHECKING MECHANICAL BACKLASH IN A DEVICE FOR OPERATING ON AN ARTICLE OR A SEMI-PRODUCT

(71) Applicant: G.D S.P.A., Bologna (BO) (IT)

(72) Inventor: Fausto MENGOLI, Bologna (IT)

(21) Appl. No.: 19/137,135

(22) PCT Filed: Dec. 13, 2023
(86) PCT No.: PCT/IB2023/062610

§ 371 Date: Jun. 9, 2025

(30) Foreign Application Priority Data
Dec. 13, 2022 (IT) 102022000025446

(51) Int. Cl. B25J 19/00; F16H 57/01; G01M 13/021

(52) U.S. Cl. CPC B25J 19/0095; F16H 57/01; G01M 13/021; F16H 2057/012

(57) ABSTRACT

A method for checking mechanical backlash in a device for operating on an article or a semi-product. The device comprises includes a motor, a manipulating means for manipulating the article or semi-product and a mechanical transmission which is operatively interposed between the motor and the manipulating means. The method includes selecting and stably blocking a reference portion of the device, relative to which an effective value of the mechanical backlash is to be calculated. Next, the method includes detecting the angular starting position of the motor and driving the motor to set the blocked reference portion in motion. Lastly, the method includes calculating an effective rotation angle size of the motor relative to the angular starting position. The effective rotation angle size is representative of the mechanical backlash between the selected reference portion and the motor.

### TECHNICAL FIELD

This invention addresses the manufacturing industry and relates to a method for checking the mechanical backlash in a device for operating on articles or semi-products.

This invention is applicable in particular in the tobacco industry, in a method for making and/or processing rod-shaped articles comprising a step of checking mechanical backlash.

### BACKGROUND ART

In the field relevant to this invention, the automatic machines used for making and/or packaging articles or semi-products have highly complex mechanical systems which include mechanical assemblies and/or operating units which work coordinatedly in conjunction with each other.

These mechanical assemblies and/or operating units are provided with motors connected to respective manipulating means by mechanical transmissions, complex in some cases, which are in turn provided with a multiplicity of components.

Assembly errors, material wear and/or overheating may cause small dimensional differences to develop between the mechanical parts making up these assemblies and/or units, which in turn lead to mechanical backlash. The increased mechanical backlash leads to a number of problems, such as, for example, non-coordinated behaviour of linked mechanical parts, undesirable speed changes and progressive loss of timing.

In other words, excessive mechanical backlash may have a negative impact on the production process, in terms of product quality and machine efficiency, as well as reduced working life of the machine itself on account of broken and/or damaged parts. Consider, for example, machines of the tobacco industry, where the extremely high speeds of the moving parts require perfect synchrony, without which jamming or breakdowns can occur, leading to machine shutdowns and maintenance action.

In this context, therefore, there is a strong need for monitoring mechanical backlash over time with a view to preventing the need for machine shutdowns and reducing maintenance downtime.

Known in the prior art are predictive control systems which use sensors to measure the vibrations produced by the machine and/or sensors to measure the operating temperature of the machine. In particular, such systems are configured to detect possible operating faults caused by the emergence of mechanical backlash which becomes evident and/or can be identified when vibrations and/or operating temperature increase.

The Applicant has observed, however, that even the latest implementations of such systems present functional drawbacks which leave room for improvement. Indeed, it was noticed that these systems are late in detecting the emergence of mechanical backlash impacting negatively on correct machine operation. It was also noticed that the emergence of mechanical backlash does not necessarily cause an increase in vibrations and/or operating temperature and that such mechanical backlash is not easy to identify with such control systems.

### Aim of the Invention

In this context, therefore, the technical purpose of this invention is to provide a method for checking the mechanical backlash in a device for operating on articles or semi-products to overcome the above-mentioned drawbacks of the prior art.

Accordingly, the aim of this invention is to provide a method that is efficient and versatile in checking the mechanical backlash in a device for operating on articles or semi-products.

Another aim of this invention is to provide a method that is efficient and versatile in checking the mechanical backlash in a device for operating on articles or semi-products and that is capable of identifying the emergence of mechanical backlash before machine functioning is negatively affected and/or the machine is damaged.

The aims are substantially achieved by a method and a device in accordance with the features set out in the accompanying claims 1, 13 and 14, respectively, and/or in one or more of the claims dependent thereon.

### BRIEF DESCRIPTION OF THE DRAWINGS

Further features and advantages of the invention are more apparent in the exemplary, hence non-limiting description which follows of a preferred but non-exclusive embodiment of a method for checking the mechanical backlash in a device for operating on articles or semi-products, and of the device in which the method can be implemented, as illustrated in the accompanying drawing, in which:

FIG. 1 is a schematic view of a device for operating on an article or semi-product according of this invention and suitable for implementing the method according to the invention.

### DETAILED DESCRIPTION OF PREFERRED EMBODIMENTS OF THE INVENTION

The invention is applicable in particular, but without thereby limiting its scope, in a method for processing rod-shaped articles of the tobacco industry. In the description of the invention that follows, therefore, reference is made to a device which is configured to operate on articles or semi-products of the tobacco industry.

It is nevertheless specified that in accordance with the generic nature of the invention, the same method for checking mechanical backlash can be implemented on devices and machines which are configured to operate on generic articles or semi-products which are not necessarily part of the tobacco industry.

The device described therefore also constitutes an exemplary application of this invention which could be applied to any kind of machine or device suitable for monitoring existing mechanical backlash.

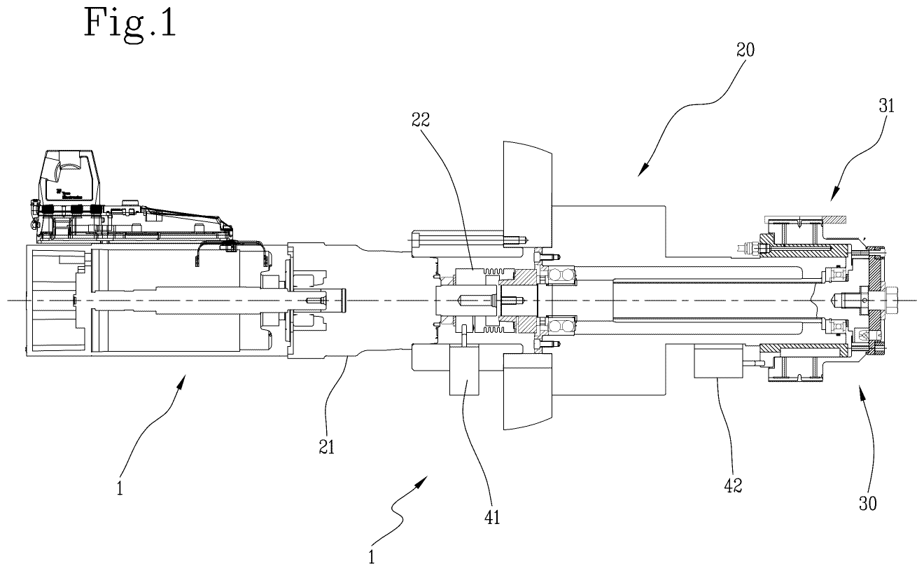

With reference to FIG. 1, the numeral 1 denotes in its entirety a device for operating on rod-shaped articles or semi-products, such as, for example, filter segments, cigarettes, tubular elements or the like. In the specific embodiment, the device 1 defines a transfer drum for transferring the articles.

In its more general aspects, the device 1 comprises a motor 10, a manipulating means 30 for manipulating the article or semi-product, and a mechanical transmission 20 interposed between them to transmit motion from the motor to the manipulating means.

The motor 10 is preferably an electric motor, in particular a servomotor.

The manipulating means 30 is thus mechanically connected to the motor 10. In the context of this invention, the term “manipulating means” is used to mean a generic mechanical part which is configured to engage the article or semi-product directly and which may be a transfer means and/or a working part or tool.

In the embodiment illustrated in FIG. 1, the device 1 in the form of a drum comprises a transfer means 31 for transferring a plurality of rod-shaped articles, in particular a mantle or in any case a rotatable, cylindrical structure: the manipulating means 30 is defined by the transfer means 31 itself, which is preferably provided with parallel arcuate seats for receiving respective rod-shaped articles. In other, different embodiments, the manipulating means 30 may be defined by a movement and/or working unit which is intended to engage the article or semi-product directly and which is movably mounted on the transfer means 31, for example a working unit rotatable about an axis perpendicular to the cylindrical surface of the drum or a folder or working unit slidable along the axis of the drum (spreading drum) or other suitable means. It is evident that there are numerous specific applications which this invention can be applied to.

The mechanical transmission 20 is operatively interposed between the motor 10 and the manipulating means 30. The term “mechanical transmission” is used generically to mean the set of mechanisms and mechanical parts whose function is to transmit the mechanical power generated by the motor 10 to the manipulating means 30, thus constituting a kinematic link.

Depending on the device, therefore, the mechanical transmission 20 may comprise a plurality of components, including shafts, belts, pulleys, chains, toothed wheels, gears, levers, link rods, gear meshing systems, cams, cam followers, couplings and motion transfer mechanisms. This list is provided by way of non-limiting example and may be further extended without thereby departing from the scope of the inventive concept.

In the preferred embodiment illustrated in FIG. 1, the mechanical transmission 20 comprises a reduction gear unit 21 connected to the motor 10 and a coupling 22 interposed between the reduction gear unit 21 and the manipulating means 30. In the case of drums with movable working units mounted on them, the mechanical transmission might comprise transmission stages even between drum rotation and movement mechanisms of the movable working units.

Preferably, the device 1 comprises an encoder (not illustrated) which is operatively associated with the motor 10. The encoder is configured to monitor the ordinary functioning of the motor 10 (speed and/or rotation phase).

Preferably, the device 1 comprises a control unit U connected to the motor 10 and/or to the encoder to carry out the method for checking mechanical backlash. In other words, when present, the control unit U is configured to carry out the method for checking mechanical backlash according to this invention in an at least partly automated manner.

The method for checking mechanical backlash is carried out at least partly, preferably entirely, in a device offline mode, in particular following an event which brings the ordinary functioning of the device 1 to a stop. In other words, the method is carried out following a stop or disabling of the motor 10 of the device correlated with the ordinary functioning of the device (operatively defined by the manipulating means).

The method comprises an initial step of selecting a reference portion of the device, relative to which an effective value of the mechanical backlash is to be calculated.

Preferably, this step of selecting may be carried out by the control unit U as a function of an automatic check routine preset in the control unit U itself. In other words, as a function of the check routine, the control unit U stops the motor 10 and starts the mechanical backlash check procedure according to this invention, using the selected reference portion as the zone of the device where the mechanical backlash is to be calculated. Alternatively, the step of selecting may be carried out by the control unit U as a function of a command entered by an operator.

The reference portion, which is effectively a physical portion of the device, may be the manipulating means 30 or a component of the mechanical transmission 20. More generally speaking, the reference portion may be any portion of the device interposed between the manipulating means and the motor, even the manipulating means itself.

Preferably, the step of selecting is carried out by selecting a reference portion from a plurality of reference portions of the device specifically intended for this purpose. These reference portions differ from each other and, in particular, are disposed in succession between the motor 10 and the manipulating means 30, more specifically along a power flow between the motor 10 and the manipulating means 30.

According to an aspect of this invention, as will become clearer as this description continues, one or more reference portions can be selected in succession within a single cycle of checking the mechanical backlash.

Irrespective of the reference portion selected, the step of selecting it is followed by a step in which the reference portion is stably blocked.

For this purpose, the device 1 may comprise at least one mechanical block disposed on a respective reference portion of the manipulating means 30 and/or of the mechanical transmission 20 to block the reference portion itself. In other words, the mechanical block prevents further movement of the respective reference portion even following a driving action by the motor 10.

According to an aspect of this invention, the device 1 may comprise a plurality of selectively engageable mechanical blocks distributed on different components between the motor 10 and the manipulating means 30, specifically in sequence along a power flow between the motor 10 and the manipulating means 30.

In the embodiment illustrated in FIG. 1, the device 1 comprises a first mechanical block 41, configured to reversibly block the reduction gear unit 21, and a second mechanical block 42, configured to reversibly block the drum mantle (manipulating means 30).

Structurally, the mechanical block may be defined by a detent (alternatively, a grub screw, a braking element or, more generally speaking, a generic stopping element) and, preferably, by an actuator connected to the control unit to move the detent. In particular, the detent is movable between an operating configuration, where the detent engages the respective reference portion (for example, in a hole or recess or, in the case of generic stop by friction, a generic surface of the reference portion), and a retracted configuration where the detent does not engage the respective reference portion.

Independently of the presence of the actuator, the mechanical detent may preferably also be moved manually by the operator.

According to an aspect of the invention, the at least one mechanical block can be engaged and disengaged automatically by a command issued by the control unit U. If a plurality of mechanical blocks is present, the control unit U is configured to automatically control at least some of the mechanical blocks, preferably all of the mechanical blocks, and more preferably, independently of each other.

The step of blocking the selected reference portion is followed by a step of detecting the angular starting position of the motor 10.

Preferably, the angular starting position of the motor 10 is detected by the encoder, connected to the control unit U. In other words, through the encoder, the control unit U is configured to detect and record the angular starting position of the motor 10.

Once the angular starting position of the motor 10 has been detected, the motor 10 itself is activated so as to try to set the blocked reference portion in motion. During this step, the movement of the reference portion prevented by the respective mechanical block. The motor 10 thus performs a partial rotation proportional to the mechanical backlash between the motor 10 and the blocked reference portion.

The partial rotation of the motor 10 is measured by calculating the effective rotation angle size of the motor 10 itself relative to its angular starting position. The effective rotation angle size is thus representative of the mechanical backlash between the reference portion and the motor 10.

The effective rotation angle size of the motor 10 is preferably calculated by the control unit U through the encoder.

At a functional level, the control unit U sets the motor 10 in motion and measures the effective rotation angle size of the motor 10 relative to the angular starting position.

According to an aspect of this invention, the step of driving the motor 10 to set the blocked reference portion in motion is carried out by driving the motor 10 in both directions, first in one direction then in the other, and, for each driving action of the motor 10, calculating the respective effective rotation angle size. Advantageously, that way, measuring errors can be reduced, if not cancelled, by measuring the real extent of the mechanical backlash. That way, in particular, the angular starting position of the motor 10 corresponds to the limit stop of a previous movement of the motor in the opposite direction.

According to an aspect of this invention, driving the motor 10 during the step of calculating the mechanical backlash is carried out using a drive torque that is lower than a drive torque generated during the ordinary functioning of the device 1. Advantageously, this avoids damaging the structure of the device 1.

It remains evident that calculating the effective rotation angle size of the motor might also be carried out by “resetting” the encoder and detecting the angle size at the end of the motor rotation.

According to an aspect of this invention, the method for checking mechanical backlash may be used to quantify the “total” mechanical backlash present between the manipulating means 30 and the motor 10. This is the case when the manipulating means 30 is selected as reference portion.

The method for checking mechanical backlash may also be used to quantify the mechanical backlash limited to a specific section of the device 1. With reference to this second case, the reference portion is selected at an intermediate point between the motor and the manipulating means.

It is also possible to select two or more distinct reference portions and to measure the mechanical backlash between the motor and each of them. In such a case, the method is preferably carried out at least twice: in particular, the method is carried out first by selecting and blocking a first reference portion and then repeating the method by selecting and blocking a second reference portion, upstream of the first reference portion (hence closer to the motor).

Reading the difference between the angular sizes measured, that is to say, subtracting one from the other via the control unit may allow calculating the mechanical backlash between the two reference portions. Thus, selecting two or more distinct reference portions makes it possible to calculate the difference between the mechanical backlash in each section of the device, thereby precisely identifying the zones where there is more backlash.

According to an aspect of this invention, the control unit U may comprise a memory unit configured to record each of the measured values of effective rotation angle size so that, for each reference portion, the control unit U can predict the trend of the mechanical backlash.

According to an aspect of this invention, once the effective rotation angle size of one reference portion has been calculated (that is, after calculating the mechanical backlash between that reference portion and the motor 10), there may be a step of comparing the effective rotation angle size with at least one threshold value.

Preferably, the threshold value represents a limit value of the effective rotation angle size (in turn corresponding to a threshold value of the mechanical backlash), exceeding which the mechanical backlash can negatively impact the production process in terms of product quality and efficiency of the device 1, and can also cause structural damage to the device 1 itself. Preferably, the threshold value is predetermined, for example at the design stage of the device 1.

The step of comparing is therefore a preliminary test for possible subsequent operations for checking the mechanical backlash in the device 1, as a function of the result of the comparison.

According to an aspect of this invention, if the effective rotation angle size is greater than or equal the at least one threshold value, there may be a subsequent step of adjusting or performing maintenance on the device 1 in order to reduce the mechanical backlash. Adjustment and maintenance of the device 1 are preferably carried out manually by an operator. In particular, the terms “adjustment” and “maintenance” can be used to mean operations to replace the components, tighten the components and, generally speaking, any operation intended to reduce the mechanical backlash in the device 1. Preferably, following adjustment and maintenance of the device 1, the method for checking the mechanical backlash (including the step of adjustment or maintenance) may be repeated cyclically until the effective rotation angle size is below the respective threshold value (thus reducing the mechanical backlash until it is below the critical value).

According to an aspect of this invention, if the effective rotation angle size is greater than or equal the at least one threshold value, there may be a step of generating a visual and/or acoustic alert signal. For this purpose, the device 1 may comprise an acoustic transducer and/or an optoelectronic device configured to generate the alert. Advantageously, that way, the operator is promptly informed of the operating condition of the device 1.

According to an aspect of this invention, if the effective rotation angle size is greater than or equal to the threshold value, the method for checking the mechanical backlash may be repeated by selecting and blocking a further reference portion that is mechanically interposed between the preceding reference portion and the motor 10. Preferably, this operation is carried out by the control unit U. Advantageously, that way, the mechanical components of the mechanical transmission 20 and/or of the manipulating means 30 responsible for the critical mechanical backlash can be precisely located and isolated.

In a preferred embodiment of the method for checking the mechanical backlash, the step of comparing is accomplished by comparing the effective rotation angle size with a first threshold value and with a second threshold value, higher than the first threshold value.

If the effective rotation angle size is between the first and the second threshold value, the device 1 generates an information signal for a user, in particular a visual and/or acoustic signal so that, depending on a predetermined protocol, the user can decide the steps to be taken.

Furthermore, if the effective rotation angle size is greater than the second threshold value, the device 1 generates an information signal for a user, in particular a visual and/or acoustic signal so that the user can proceed to adjusting and/or performing maintenance on the device as described herein.

Whatever the case, following adjustment or maintenance on the device 1, the method may be repeated cyclically until the mechanical backlash is reduced.

It is stressed that, according to an aspect of this invention, the method can in any case be integrated with the above-mentioned prior art control systems in order to further improve the checking of mechanical backlash. For this purpose, the device 1 may be provided with sensors which are configured to measure vibrations and/or operating temperature and, in particular, to detect anomalous values of vibration and/or operating temperature.

The invention achieves the above-mentioned aims by eliminating the drawbacks of the prior art: in this regard, it should first of all be noted that the method as described and/or claimed herein allows obtaining an efficacious and versatile system for checking mechanical backlash. In particular, the method as described and/or claimed herein allows identifying the emergence of mechanical backlash before machine functioning is negatively affected and/or the machine is damaged. These results are achieved especially thanks to the possibility of promptly detecting the presence and/or the emergence of mechanical backlash through the above-mentioned steps performed on portions of the device 1.

Moreover, the device 1 as described and/or claimed herein allows implementing the method described herein, thus allowing the mechanical backlash to be checked in an efficient and versatile manner.

1. A method for checking mechanical backlash in a device for operating on an article or a semi-product, the device comprising a motor, a manipulating means for manipulating the article or semi-product and which is mechanically connected to the motor, and a mechanical transmission which is operatively interposed between the motor and the manipulating means; the method comprising the steps of:
selecting a reference portion of the device, relative to which an effective value of the mechanical backlash is to be calculated;
stably blocking the reference portion;
detecting the angular starting position of the motor;
driving the motor to set the blocked reference portion in motion;
calculating an effective rotation angle size of the motor relative to the angular starting position; the effective rotation angle size being representative of the mechanical backlash between the selected reference portion and the motor.

2. The method according to claim 1, wherein the reference portion is defined by the manipulating means.

3. The method according to claim 1, wherein the reference portion is defined by a component of the mechanical transmission.

4. The method according to claim 1, wherein the step of selecting a reference portion is carried out by selecting a reference portion from a plurality of different reference portions of the device, in particular the reference portions being disposed in succession between the motor and the manipulating means.

5. The method according to claim 1, comprising a subsequent step of comparing the effective rotation angle size with at least one threshold value; if the effective rotation angle size is greater than or equal to at least one threshold value, the method comprising a subsequent step of adjusting or performing maintenance on the device to reduce the mechanical backlash and including preferably generating a visual and/or audible alarm.

6. The method according to claim 5, wherein, if the effective rotation angle size is greater than or equal to the threshold value, the method is repeated by selecting and blocking a further reference portion that is mechanically interposed between the preceding reference portion and the motor.

7. The method according to claim 5, comprising a subsequent step of comparing the effective rotation angle size with a first threshold value and a second threshold value that is greater than the first threshold value; if the effective rotation angle size is between the first and the second threshold value, the method comprising a step of generating an information signal for a user, specifically a visual and/or audible signal; if the effective rotation angle size is greater than the second threshold value, the method comprising the step of adjusting or performing maintenance on the device to reduce the mechanical backlash.

8. The method according to claim 5, wherein the method is repeated if the step of adjusting or performing maintenance on the device has been performed.

9. The method according to claim 1, wherein the steps of stably blocking the reference portion, detecting the angular starting position of the motor, and driving the motor to set the blocked reference portion in motion are carried out in offline mode following a stop in the ordinary operation of the device.

10. The method according to claim 1, wherein the step of driving the motor is carried out using a drive torque that is lower than a drive torque generated during the ordinary operation of the device.

11. The method according to claim 1, wherein the step of driving the motor to set the blocked reference portion in motion is carried out by driving the motor in both directions and, for each driving action of the motor, calculating the respective effective rotation angle size.

12. The method according to claim 1, wherein the device comprises an encoder that is operatively associated with the motor, specifically for monitoring the ordinary operation of the motor, the effective rotation angle size being measured by the encoder.

13. The method according to claim 1, wherein the device comprises a transfer means, specifically a drum, for transferring a plurality of rod-shaped articles, and wherein the manipulating means is defined by the transfer means or by a movement and/or working unit designed to directly engage the article or semi-product and movably mounted on the transfer means.

14. A method for processing rod-shaped articles of the tobacco industry, comprising a step of checking the mechanical backlash performed according to claim 1.

15. A device for operating on an article or semi-product, comprising a motor, a manipulating means for manipulating the article or semi-product and which is mechanically connected to the motor, and a mechanical transmission which is operatively interposed between the motor and the manipulating means, further comprising at least one mechanical block disposed on a reference portion of the mechanical transmission and/or of the manipulating means to controlledly block the reference portion and thus prevent further movement of the reference portion following the driving action of the motor;
wherein the device also comprises a control unit connected to the motor and/or to an encoder associated with the motor to implement a method for checking mechanical backlash, specifically a method according to claim 1, wherein, after the step of blocking the reference portion, the control unit sets the motor in motion and measures the effective rotation angle size of the motor, the effective rotation angle size being representative of the mechanical backlash between the reference portion and the motor.

16. The device according to claim 15, wherein the at least one mechanical block can be automatically engaged and disengaged by means of a command issued by the control unit.

17. The device according to claim 15, comprising a plurality of selectively engageable mechanical blocks distributed on different components between the motor and the manipulating means, specifically in sequence along a power flow between the motor and the manipulating means.
